(19) United States
(12) Patent Application Publication
(10) Pub. No.: US 2016/0077945 A1
(43) Pub. Date: Mar. 17, 2016

(54) STORAGE SYSTEM STATISTICAL DATA STORAGE AND ANALYSIS

(71) Applicant: NetApp, Inc., Sunnyvale, CA (US)

(72) Inventors: Pradeep K. Kalra, San Jose, CA (US); Ramachaitanya Kavuluru, Santa Clara, CA (US); Andrew K. Taeoalii, Santa Clara, CA (US); Jing Shi, Sunnyvale, CA (US)

(21) Appl. No.: 14/483,946

(22) Filed: Sep. 11, 2014

(51) Int. Cl. G06F 11/30; G06F 17/30; G06F 11/34

(52) U.S. Cl. CPC G06F 11/3037; G06F 11/3409; G06F 17/30312

(57) ABSTRACT

First performance data is obtained from active data sources for components of a storage system into execution space of an operating system. Second performance data is derived from the first performance data. The first performance data and the second performance data is grouped into a data unit that can be written to a data structure. The data unit is written to the data structure.

### BACKGROUND

The disclosures herein generally relate to the field of storage systems, and, more particularly, to analysis of storage system related statistical data.

Tracking various aspects of storage system operation and performance can generate large amounts of data. An enterprise-level storage system, for example, might include one or more storage controllers coupled with many storage devices. The storage controllers and/or other components might include many different layers of software that perform various functions, such as interacting with other components using differing protocols, supporting hardware functionality, etc. Any number of these components, both hardware and software, might track various aspects of performance, such as the number of read and write operations performed, the number of errors that have occurred, etc. Access to this data can help in troubleshooting issues that arise, determining when upgrades should be performed, etc. However, collecting, analyzing, and storing this data can use a large amount of computing resources, taking those computing resources away from other storage system operations, such as reading and writing user data to storage devices of the storage system.

### BRIEF DESCRIPTION OF THE DRAWINGS

The examples herein may be better understood, and numerous objects, features, and advantages made apparent to those skilled in the art by referencing the accompanying drawings.

FIG. 1 depicts an example storage controller with a storage controller-based statistical archiver that collects and analyzes data from various storage system data sources.

FIG. 2 depicts a flowchart of example operations for registering and sampling a data source.

FIG. 3 depicts a flowchart of example operations for receiving and processing response to a request for a data source sample.

FIG. 4 depicts an example archiver that resamples data from various storage system data sources.

FIG. 5 depicts a flowchart of example operations for receiving and processing response to a request for a data source sample.

FIG. 6 depicts an example computer system including an archiver.

### DETAILED DESCRIPTION OF EXAMPLE ILLUSTRATIONS

The description that follows includes example systems, methods, techniques, instruction sequences and computer program products that embody techniques of the disclosures herein. However, it is understood that the described aspects may be practiced without these specific details. For instance, although examples refer to asynchronous messages, other forms of communication can be used. In other instances, well-known instruction instances, protocols, structures and techniques have not been shown in detail in order not to obfuscate the description.

Collecting, analyzing, and storing data generated by the components of a storage system can hamper performance of the storage system by taking computing resources away from actual storage system operations, such as reading and writing user data to storage devices of the storage system. To reduce the impact on storage system operations, the actual analysis of the data might be performed at a later point in time, such as when the data is copied to a computing system separate from the storage system. The delay between the sampling of the data and the analysis of the data can reduce the effectiveness of the analysis. Further, it may not be possible to analyze the entire volume of data. For example, the volume of data might be too large to copy to another computing system, thus resulting in some data being excluded from the analysis.

A storage system can be designed to efficiently collect, analyze, and resample data within the storage system itself. In particular, a storage controller or other storage system component includes a statistical archiver that allows various storage system components to register data sources, such as counters. The statistical archiver then gathers data from the data sources based on various parameters, such as sample interval. The gathered data is then analyzed and stored on the storage controller (or other storage system component).

Various operations of the statistical archiver and related components are implemented to reduce the impact of the operations on the storage system. For example, when gathering the data from the data sources, the statistical archiver can use asynchronous messages, allowing the data gathering to be deferred based on the availability of computing resources. Further, the statistical archiver can store the data using techniques that reduce the impact of associated write operations as well as resampling older data at coarser granularities, thus reducing the amount of storage used by the statistical data. Further, the statistical archiver can provide an interface to the data, allowing the data to be viewed directly from the storage system. Thus, the statistical archiver provides a more contemporaneous and complete view of the storage system operations.

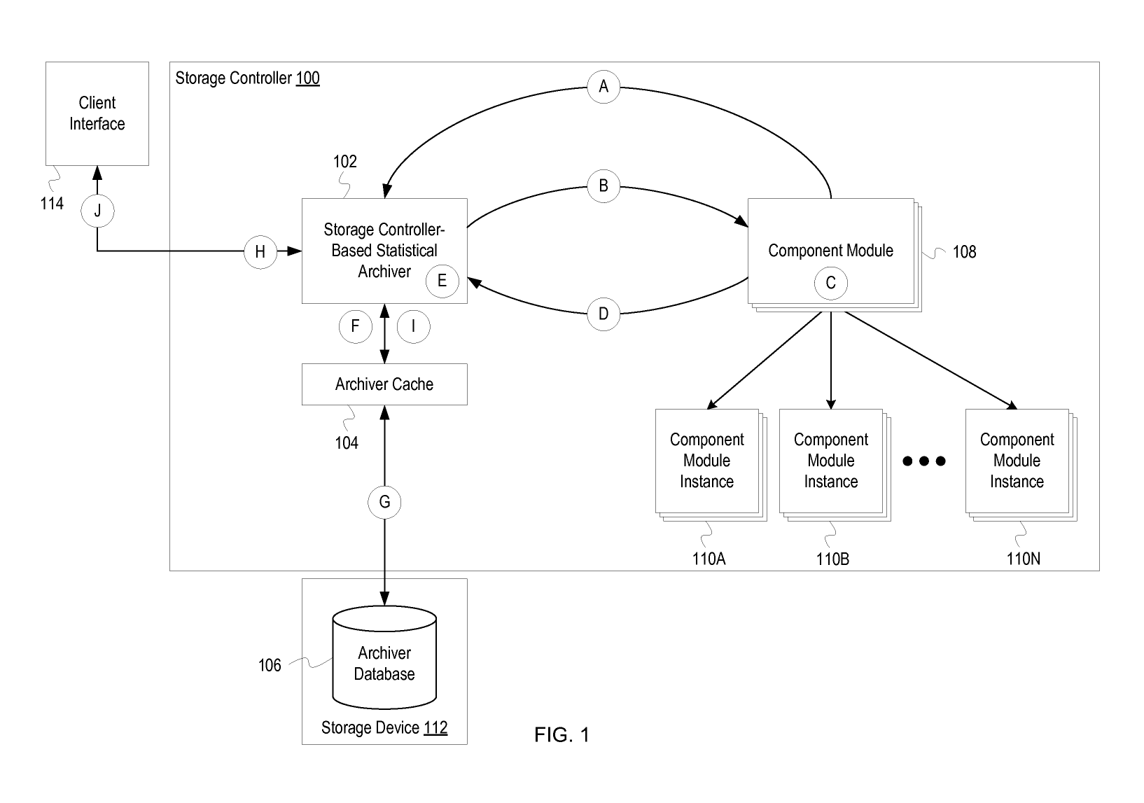

FIG. 1 depicts an example storage controller with a storage controller-based statistical archiver that collects and analyzes data from various storage system data sources. FIG. 1 depicts a storage controller 100, which is part of a storage system (not depicted). The storage controller 100 includes a storage controller-based statistical archiver (hereinafter “archiver”) 102 and an archiver cache 104. An archiver database 106 is located on a storage device 112. The storage controller 100 is communicatively coupled with the storage device 112, thus communicatively coupling the archiver 102 and the archiver database 106. The storage controller 100 also includes a set of component modules 108 and component module instance sets 110A-N. FIG. 1 also depicts a client interface 114.

The archiver 102 can be a software module executing on the storage controller 100 alone or as a part of an operating system. The archiver 102 can operate as a service, a background process, etc. Thus, for example, the archiver 102 can execute within the execution space of the operating system, which includes the memory utilized by the operating system.

Each component module of the set of component modules 108 represents a particular storage system component, which can vary widely. For example, a component module of the set of component modules 108 might represent a particular type of storage object, such as a volume, which is a logical construct. A component module instance of each of the component module instance sets 110A-N might then represent actual volume instances configured in the storage system. As another example, a component module of the sets of component modules 108 might represent a particular type of hardware component, such as a network interface card, which is a physical device. A component module of each of the component module instance sets 110A-N might then represent individual network interface cards coupled with the storage controller 100.

In order to simplify the description below, a single component module from the set of component modules 108 will be described (referred to hereinafter as “component module 108”). Similarly, only one component module instance from each of the component module instance sets 110A-110N will be described (referred to hereinafter as “component module instances 110A-110N”).

At stage A, the component module 108 registers one or more data sources with the archiver 102. To register the data sources with the archiver 102, the component module 108 sends metadata associated with each data source to the archiver 102. The metadata associated with each data source includes at least a data source identifier. The metadata associated with each data source can also include an initial sampling interval, one or more indications of how long data sampled from the data source should be preserved at particular granularities (described in more detail below) and/or what sampling intervals to use for each granularity.

The data sources include data sources from the component module instances 110A-N, if applicable. In other words, while each of the component module instances 110A-N might include the same data sources, some of the component module instances 110A-N might instead include different data sources or no data sources at all. The data sources also include data sources from the component module 108 itself, including data sources derived by aggregating data from the component module instances 110A-N.

The initial registration of the data sources generally occurs during a storage controller boot process or when the component module 108 is activated or deactivated. However, if data sources are added, removed, or modified (including the configuration thereof), the component module 108 might register the changes with the archiver 102 at various other points in time.

At stage B, the archiver 102 requests a sample of the data sources from the component module 108. To sample the data sources, the archiver 102 sends a request to the component module 108 for data from the data sources. For example, if a data source is a counter, a sample of the counter would be the current value of the counter.

The request can include an identifier for each of the data sources (as indicated by the component module 108 at stage A) or can be a general request for data. When the request is a general request that does not specify the particular data sources, the component module 108 can identify the appropriate data sources by, for example, determining which data sources were registered with the archiver 102 or return data for all data sources.

The particular data sources sampled can vary based on the sampling interval specified when the data sources were registered. For example, a sample might be requested every second for data sources associated with a sampling interval of one second, while a sample might be requested every five seconds for data sources associated with a sampling interval of five seconds. Thus, samples taken every second include data sources with a sampling interval of one second while samples taken every five seconds also include data sources with a sampling interval of five seconds.

The archiver 102 requests the sample of the data sources using an asynchronous message. In this particular example, messages can be associated with a particular task. For example, in this instance, the message sent by the archiver 102 is associated with the task of gathering the sample data and returning the sample data to the archiver 102. Asynchronous messages allow the operating system (not depicted) to control the scheduling of the task associated with the message. For example, the archiver 102 might request the sample of the data sources at time τ₁, but the operating system might schedule the associated task (e.g., the operations depicted below at stage C) to execute until other, higher priority tasks have completed. Thus, utilization of asynchronous messages allows the archiver 102 to request the data without preventing other tasks from executing. By allowing the operating system to schedule the tasks associated with the asynchronous messages, the operating system can effectively suspend the sampling of the data sources when higher priority tasks are ready to be performed.

At stage C, the component module 108 gathers data from the data sources that are associated with the component module instances 110A-N. To gather the data from the data sources associated with the component module instances 110A-N, the component module 108 can request the data from the component module instances 110A-N, read the data directly from the component module instances 110A-N, etc. The collection of data from the component module instances 110A-N by the component module 108 might occur on an ongoing basis as well. In other words, the component module 108 might periodically gather data from the component module instances 110A-N even if no request is received from the archiver 102. Further, the component module 108 might maintain one or more of the component module instance data sources itself. For example, instead of the component module instance 110A maintaining a particular counter, the component module 108 might maintain the counter itself, incrementing the counter based on an indication from the component module instance 110A.

At stage D, the component module 108 sends the data to the archiver 102. The component module 108 can send the data to the archiver 102 in a reply to the original request message. The data can be organized based on relationships between the individual data sources. For example, data associated with component module data sources might be grouped together while data associated with data sources for a particular component module instance might be grouped separately.

At stage E, the archiver 102 parses and analyzes the data from the component module 108. To parse the data, the archiver 102 identifies the individual data sources within the data received from the component module 108. For example, the data might be formatted such that the data sources from each individual component module instances are grouped together. Further, the archiver 102 might also identify data sources that are associated with other data sources, such as a base counter used to calculate latency. The archiver 102 might also identify data associated with previously collected samples.

The archiver 102 can utilize asynchronous messages for the parsing and analysis of the data. In other words, the archiver 102 can allow the operating system to schedule the actual operations associated with the parsing and analysis. For example, the archiver 102 might send an asynchronous message that is associated with the parsing and analysis tasks to the operating system. The operating system then schedules the parsing and analysis tasks, taking into account other tasks that may be higher priority, already executing, etc. When the operating system determines that the parsing and analysis tasks can execute, the operating system can notify the archiver 102.

The archiver 102 analyzes the data according to the particular types of statistical data desires. For example, a data source might be used to calculate a rate, an average, or be used as raw data. Consider the calculation of the number of read operations per second (a rate). To calculate the number of read operations per second, the archiver 102 identifies a data source that specifies the total number of read operations that have occurred (hereinafter “read operation counter”). The archiver 102 further identifies a previous sample of the read operation counter (e.g., the total number of read operations reported by the read operation counter when previously sampled). The archiver 102 then subtracts the number of read operations indicated in the most recent sample by the number of read operations indicated in the previous sample and divides the difference by the sampling interval. Each sample might be time stamped, allowing the archiver 102 to compensate for instances in which responses to the sample requests were not received within the period indicated by the associated sampling interval.

Averages can be calculated similarly. For example, average latency can be calculated by dividing the number of seconds that have elapsed during an interval by the number of operations performed during the same interval. For example, the average latency of read operations over a five second interval can be determined by dividing the interval length (five seconds) by the number of read operations that were performed during that interval. In relation to the average latency calculation, the number of operations that were performed during the particular interval serves as the base value, and the interval length is an example of a base counter.

Some data sources might be used as raw data. For example, a particular counter data source might be incremented each time an error occurred. If the total number of errors is a relevant statistic, data from the error counter data source can be used without further analysis.

The archiver 102 can store the sampled data, along with the data calculated using the sampled data, in memory. For example, the archiver 102 might store the sampled data in a data structure that identifies the data source, indicates when the same was taken, and includes the sampled data itself. As described above, this can be used to, for example, analyze data from future samples.

At stage F, the archiver 102 writes the sampled data to the archiver cache 104. The data is identified by the particular timestamp associated with the time the sample was requested or received and the particular component module instance the data source is associated with. The archiver 102 writes the data using techniques that reduce the impact of the write operation on the storage controller 100. For example, instead of writing each data source as a separate entry in the archiver cache 104, the archiver 102 can write a single entry that includes each data source. Table 1, below, depicts the archiver cache 104 with entries for each data source.

TABLE 1

| Timestamp | Instance | Data Source Identifier | Value |
|---|---|---|---|
| 1410106861 | A | Data-Source-1 | V₁ |
| 1410106861 | A | Data-Source-2 | V₂ |
| 1410106861 | A | Data-Source-3 | V₃ |

Table 2, below, depicts the archiver cache 104 with a single entry for all data sources.

TABLE 2

| Timestamp | Instance | Data-Source-1 | Data-Source-2 | Data-Source-3 |
|---|---|---|---|---|
| 1410106861 | A | V₁ | V₂ | V₃ |

As can be seen by comparing Table 1 and Table 2, writing a single entry for each sample, instead of a single entry for each data source, reduces the amount of redundant data. In this specific example, the amount of data used by the timestamp and the component module instance identifier is reduced by two-thirds. Further, each data source identifier is only used once regardless of how many samples of the data source are used.

In addition to reducing the amount of space used to store data, writing a single entry for all data sources can also reduce the amount of other computing resources used. For example, writing a single entry might be accomplished using a single write operation, while writing multiple entries might use multiple write operations. For similar reasons, using single entries per sample can also reduce the amount of computing resources used when reading the data as well.

At stage G, the archiver 102 flushes the data from the archiver cache 104 to the archiver database 106. While the archiver 102 might write data to the archiver cache 104 as the data is processed (e.g., sample by sample), the archiver 102 typically flushes the data from the archiver cache 104 to the archiver database 106 on a more periodic basis. This allows the archiver 102 to further reduce the impact of storing the data on the storage controller 100.

Consider that, in this example, the archiver cache 104 is located in memory, such as random access memory (RAM) on the storage controller 100. Further consider that the archiver database 106 is located on the storage device 112 attached to the storage controller 100. Writes to RAM typically occur at a finer granularity than writes to the storage device 112. For example, writes to RAM might be sixty-four bytes in size, while writes to the storage device 112 might be four kilobytes (4096 bytes) in size. Thus, while it might be fairly efficient to write individual entries to the archiver cache 104, it might be inefficient to write individual entries to the archiver database 106. To compensate for the differing write granularity, the archiver 102 writes individual entries to the archiver cache 104 until the amount of data in the archiver cache 104 is nearer to the size of the data of a write operation. Once the archiver cache 104 contains sufficient data, the archiver 102 flushes the data in the archiver cache 104 to the archiver database 106.

The archiver 102 further functions as an interface between entities that use the data, such as the client interface 114, and the data itself. This allows the archiver 102 to hide various implementation details from other entities, such as the use of the archiver cache 104. Similarly, the archiver 102 can identify gaps in the data, inserting indications of the gaps compatible with the client interface 114. Stages H through J depict example interactions between the client interface 114 and the archiver 102, which can happen independently of and/or concurrently with stages A through G.

At stage H, the client interface 114 queries the archiver 102 for previously collected data. The client interface 114 can query the archiver 102 using an application programming interface (API) implemented by the archiver 102. A query from the client interface 114 can request data for a specific period of time, for specific component modules, for one or more component modules and/or component module instances, one or more specific data sources, etc. Further, a query can indicate that data be aggregated across multiple component modules or component module instances, if applicable, to provide summary data or otherwise indicate that data should be returned at various levels of detail.

At stage I, the archiver 102 queries the archiver cache 104 for the data. The archiver 102 queries the archiver cache 104 for the data in order to get the most recent data collected. Consider, for example, a scenario in which the archiver 102 queried the archiver database 106 directly. Any data in the archiver cache 104 that has not been flushed to the archiver database 106 would not be returned in response to the query. Thus, the archiver cache 104 acts as an interface to the archiver database 106. When the archive cache 104 receives the query, it can retrieve responsive data from the archiver database 106 and merge the retrieved data with the latest data in the archiver cache 104 itself. Thus, the archiver cache 104 returns the most recently stored data, which might not be available by querying the archiver database 106 directly.

At stage J, the archiver 102 processes the data returned by the archiver cache 104 and sends the data to the client interface 114. While the particular operations performed by the archiver 102 to process the data can vary, in this example the archiver 102 identifies gaps in the data for which samples are missing. For example, consider a scenario in which the component module 108 failed to respond to a request for a sample within the sample interval. The archiver 102 would thus skip or delay at least one request for a sample, resulting in a gap in the data. In some instances, the archiver 102 might interpolate the missing data based on the nearest samples before and after the gap. However, interpolating the data might lead the entity using the data to conclude or assume that the data is accurate, when it might not be. Thus, the archiver 102 can, in some instances, specifically indicate the presence of a gap in the data. The technique(s) used to indicate the gaps can vary depending on the specific format of the data expected by the client interface 114 (or other entity). For example, the archiver 102 might insert samples where the missing samples should be, while indicating that the sample is a null value. As another example, the archiver 102 might include an entry that identifies the beginning and end of the gap. The archiver 102 then sends the processed data to the client interface 114 in accordance to the API or protocol used by the client interface 114 to communicate with the archiver 102.

The sampling of the data sources is, typically, lower priority than various other storage system operations (such as reading and writing user data to storage devices of the storage system). Thus, it is possible that the component module 108 does not respond to a request for a sample within the period of time indicated by the sampling interval (as mentioned above). In other words, if the sampling interval for a data source is one second, the archiver 102 might not receive a sample of the data source until more than a second after the request is sent. To compensate for such scenarios, the archiver 102 might only send a second request for a sample if a response to a previous request was received. This prevents the archiver 102 from continuing to send messages to the component module 108 while the component module 108 is busy. If the response takes longer than the period of time indicated by the sampling interval, the archiver 102 can send the next request either on the next interval after receiving a response from the component module 108 or immediately after receiving the response.

Overhead associated with the communications between software components, such as the archiver 102 and the component module 108, can be further reduced by executing the components within the same process. Consider, for example, a scenario in which the archiver 102 and the component module 108 execute in different processes. To pass communications between processes, the operating system performs a context switch from the process sending a message to the process receiving the message. The context switch generally involves exchanging a large amount of data in a processor associated with one process with the data of another process. By executing the archiver 102 and the component module 108 within the same process (by using threads, for example), the overhead associated with a full context switch is avoided when passing messages back and forth.

In the example described above, the component module 108 functions as the interface between the archiver 102 and the component module instances 110A-N. In other words, the component module 108 gathers the data from the component module instances 110A-N. The archiver 102, however, can be designed to communicate with the component module instances 110A-N directly. The component module 108 might, for example, register each component module instance 110A-N with the archiver 102, thus allowing the archiver 102 to gather the data from the component module instances 110A-N itself.

While the archiver 102 is described as requesting the data from the data sources by sending an asynchronous message to the component module 108, other techniques can be used. For example, the archiver 102 can request the data from the component module 108 using a function call or a synchronous message.

The description above at stage A includes some examples of metadata that can be associated with a data source. Additional examples include labels for the associated component module and component module instance (e.g., descriptive names used by users/administrators), units of measurement, and indications of additional operations used to convert/translate sampled data into a more usable form.

In the example above, the archiver 102 writes an entry that includes the sampled data to a table in a database. An entry is an example of a data unit that can contain the sampled data and associated metadata. The table is one example of a data structure that can be used to store multiple data units. Similarly, the database is an example of a data store that can group together multiple data structures. The

Maintaining the data for a large number of frequently sampled data sources can use a large amount of storage. To reduce the amount of storage used, the data can be resampled as the data “ages”. For example, samples of a data source might be maintained at the configured sampling interval (e.g., one second) for several hours. After several hours, the data from the data source might be resampled to a lower sampling interval (e.g., fifteen seconds), which might be maintained for a day. Thus, data from the data sources can be repeatedly resampled, with the new samples being maintained for increasing longer periods of time. Each time the data is resampled, the finer-grained data is removed.

It should be noted that while the archiver cache 104 and the archiver database 106 are depicted separately, the archiver cache 104 and archiver database 106 might operate as a single entity. The archiver cache 104 and archiver database 106 can thus be implemented such that the functionality of the archiver cache 104 is virtually transparent to the archiver 102. In other words, the archiver 102 might be implemented such that it appears to write data straight to the archiver database 106, while the archiver database 106 actually performs the functions described above, such as those depicted at stage G.

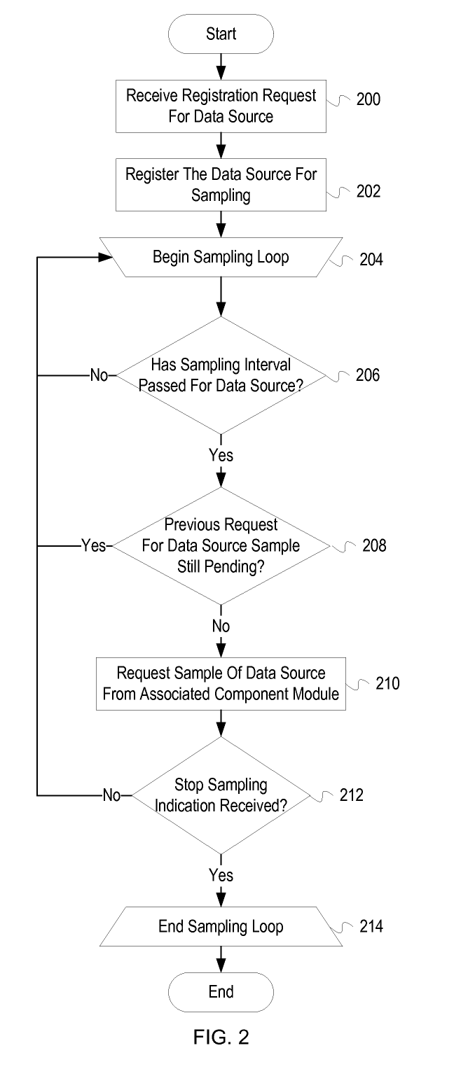

FIG. 2 depicts a flowchart of example operations for registering and sampling a data source. The operations depicted in FIG. 2 can be performed by the archiver 102, depicted in FIG. 1, or another component configured to perform the operations.

At block 200, an archiver receives a registration request for a data source. The registration request can be received via a function call, message, etc. The registration request identifies the data source, and can also indicate additional metadata, such as a sampling interval, one or more resampling intervals, lengths of time to maintain samples corresponding to the sampling/resampling intervals, related data sources etc. If associated with a component module instance, the data source can be identified by a component module instance identifier in addition to a data source identifier. After the archiver receives the registration request for the data source, control then flows to block 202.

At block 202, the archiver registers the data source for sampling. The operations for registering the data source for sampling can vary. Generally, however, the archiver stores an indication of the data source along with the associated metadata. The archiver might group the data source with other data sources from the same component module instance (if applicable) and/or other data sources sampled on the same intervals. The archiver might also initialize additional data structures to store the actual samples (including multiple samples, if applicable). The archiver might also communicate with additional components. For example, the archiver might use a timer module to notify the archiver when a sampling interval has passed. In such instances, the archiver might pass an indication of the sampling interval to the timer module. After the archiver 202 registers the data source for sampling, control then flows to block 204.

At block 204, the archiver initializes or updates data associated with a sampling loop. During the first pass through block 204, the archiver initializes any data structures, variables, etc., used during the sampling loop. For example, the archiver might initialize and initiate a timer. The initialization of one or more of the data structures described at block 202 might be performed at block 204 instead. During the subsequent passes through block 204, the archiver updates the data structures, variables, etc., as appropriate. After the archiver initializes or updates the data associated with the sampling loop, control then flows to block 206.

At block 206, the archiver determines whether a sampling interval for the data source has passed. To determine whether the sampling interval for the data source has passed, the archiver can determine the amount of time that has elapsed since the previous sample was requested. If the amount of time that has elapsed is greater than the sampling interval, the sampling interval has passed. The archiver might precompute the sampling interval instead of determining the amount of time that has passed. For example, assume that the sampling interval of a particular data source is five seconds. When the archiver requests a sample, the archiver can generate a timestamp for the request, add five seconds to the timestamp, and save the new timestamp. Thus, to determine whether the sampling interval has passed, the archiver can compare the saved timestamp with a current timestamp. If the current timestamp is greater than the saved timestamp, the sampling interval has passed. If the archiver determines that the sampling interval for the data source has passed, control then flows to block 208. If the archiver determines that the sampling interval for the data source has not passed, control then flows back to block 204.

At block 208, the archiver determines whether a previous request for a sample of the data source is still pending. The archiver can maintain an indication of whether a previous request is outstanding, such as a Boolean variable associated with the particular data source. The archiver then checks the indication to determine whether the previous request is still pending. If the archiver determines that a previous request for a sample of the data source is still pending, control then flows back to block 204. If the archiver determines that no previous request for a sample of the data source is still pending, control then flows to block 210.

At block 210, the archiver requests a sample of the data source from a component module associated with the data source. To request a sample of the data source from the component module, the archiver sends an asynchronous message to the component module. The message typically identifies at least the data source, including an associated component module instance, if applicable. In some instances, the data source might not be explicitly identified (e.g., if the component module can determine the appropriate data source itself). After the archiver requests the sample of the data source from the component module, control then flows to block 212.

At block 212, the archiver determines whether a stop sampling indication has been received. A stop sampling indication might be received if, for example, the storage system is being shut down or an administrator turns off data collection. If a stop sampling indication has been received, control then flows to block 214. If a stop sampling indication has not been received, control then flows back to block 204.

At block 214, the archiver ends the sampling loop, cleaning up and/or removing any data structures no longer in use. After the archiver ends the sampling loop, the process ends.

FIG. 2 depicts the operations as being performed with individual data sources to simplify the description of the operations. Many of the operations can be implemented to apply to one or more data sources instead. For example, a registration request might indicate a set of one or more data sources and one or more data sources might be sampled at once.

It should also be noted that the sampling loop might not begin immediately after registering the data source at block 202. For example, the receiving of the registration request and registration of the data source (depicted at blocks 200 and 202 of FIG. 2) might occur during a boot process. The sampling loop, on the other hand, might be initiated separately, such as after the boot process (e.g., after all data sources are registered).

Further, while FIG. 2 depicts the sampling operations as occurring as part of a loop, the sampling operations can be implemented using events (or similar concept). For example, instead of repeatedly determining whether a sampling interval for a data source has passed (as depicted at block 206), the archiver might wait for a notification from another component that indicates that the sampling interval has passed.

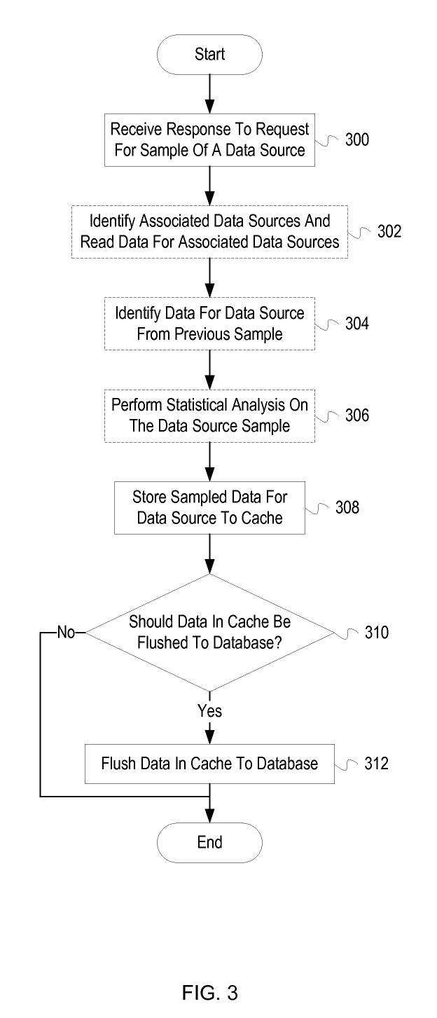

FIG. 3 depicts a flowchart of example operations for receiving and processing a response to a request for a data source sample. The operations depicted in FIG. 3 can be performed by the archiver 102, depicted in FIG. 1, or another component configured to perform the operations. It should be noted that, due to the large number of possible data source types and statistical information that can be calculated from the data sources, FIG. 3 does not depict all possible operations that might be performed to process the response. In particular, the operations depicted in FIG. 3 focus on the use of counters to determine rates, averages, etc. The operations at blocks 302, 304, and 306 are depicted as optional because some data sources might be used without analysis (such as an error counter, as described above). The operations depicted in FIG. 3 can be adapted for other data sources and statistical metrics.

At block 300, the archiver receives a response to a request for a sample of a data source. The response at least includes the sampled data from the data source (hereinafter “sampled data source”). The response can also include a request identifier, data source identifier, component module instance identifier, etc. The archiver can extract the sampled data from the response and store the sampled data in one or more data structures associated with the particular sampled data source. After the archiver receives the response to the request for the data source sample, control then flows to one of blocks 302, 304, 306, or 308, based on the particular sampled data source.

At block 302, the archiver optionally identifies and reads data sources associated with the sampled data source. The archiver can identify the associated data sources by determining whether metadata associated with the sampled data source indicates that the sampled data source has associated data sources. Associated data sources might include, for example, a base counter, as described above. Once the associated data sources have been identified, the archiver can read sampled data for the associated data sources, which can be maintained by the archiver. After the archiver identifies associated data sources and reads sampled data for the associated data sources, control then flows to one of blocks 304, 306 or 308, depending on the particular sampled data source type.

At block 304, the archiver optionally identifies data for the sampled data source from previous samples. As described above, the archiver can maintain data from past samples of data sources. Thus, the archiver can look up the sampled data from previous samples of the sampled data source. The previous sample data can be useful for determining various statistics, such as rates and averages. After the archiver identifies data for the sampled data source from previous samples, control then flows to one of blocks 306 or 308, depending on the particular sampled data source type.

At block 306, the archiver optionally performs statistical analysis on the sample data of the sampled data source. The specific operations performed can vary depending on the particular data source and statistical information desired. To determine a rate, such as the number of read operations per second, the archiver can determine the difference between the current sampled data and the previous sampled data, then divide the difference by the amount of time that elapsed between the samples. After the archiver performs the statistical analysis on the sample data, control then flows to block 308.

At block 308, the archiver stores the sampled data for the data source to a cache. The archiver can store the sampled data by writing an entry that includes the sampled data to the cache. The entry can also include a timestamp and a component module instance identifier. Further, as described above, the entry might include data from other data sources in addition to the sampled data, such as data from associated data sources. After the archiver stores the sampled data to the cache, control then flows to block 310.

At block 310, the archiver determines whether data should be flushed from the cache to a database. The archiver can use various factors to make the determination. For example, the archiver can determine whether the size of the data in the cache has reached a threshold. The threshold might be related to the minimum amount of data written to a storage device as part of a write operation. The archiver might also determine whether the number of updated entries in the cache has reached a threshold. The archiver might also periodically flush the data to the database. Thus, the archiver might determine whether a particular period of time has elapsed since the last time data in the cache was flushed to the database. If the archiver determines that the size of the data in the cache has reached the threshold, control then flows to block 312. If the archiver determines that the size of the data in the cache has not reached the threshold, the process ends.

At block 312, the archiver flushes the data in the cache to a database or other backing store. To flush the data to the database, the archiver can write the data in the cache to the database and indicate that the data in the cache can be replaced. The cache itself might implement functionality to write the data to the database itself. For example, the cache and/or database might implement transaction semantics. In such instances, the archiver might issue a command to the cache and/or database indicating the end of a transaction, which would result in the data being flushed from the cache to the database. After the archiver flushes the data in the cache to the database, the process ends.

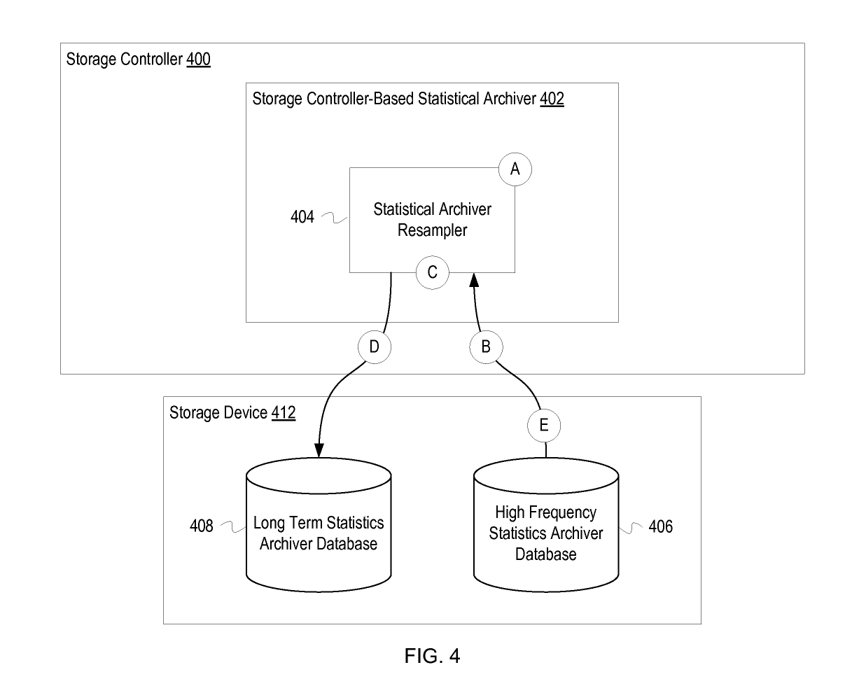

FIG. 4 depicts an example archiver that resamples data from various storage system data sources. FIG. 4 depicts a storage controller 400, which is part of a storage system (not depicted). The storage controller 400 includes an archiver 402. The archiver 402 includes a statistical archiver resampler (hereinafter “resampler”) 404. FIG. 4 also depicts a storage device 412 that includes a high frequency archiver database (hereinafter “HF database”) 406 and a long term statistics archiver database (hereinafter “LT database”) 408. As described above, the storage controller 400 is communicatively coupled to the storage device 412.

At stage A, the resampler 404 determines that data in the HF database 406 should be resampled. Various factors can go into a determination that data in the HF database 406 should be resampled. For example, the resampler 404 might periodically resample the data in the HF database 406. Thus, the resampler 404 might resample the data after determining that a specific amount of time has passed. As another example, the resampler 404 might resample the data in the HF database 406 after determining that the space used by the HF database 406 has reached a threshold. Further, the resampler 404 might resample the data in the HF database 406 after receiving an indication from another component indicating that the data should be resampled.

At stage B, the resampler 404 reads the data to be resampled from the HF database 406. The data to be resampled can be any data older than a specific age (e.g., three hours old). The specific age can also be determined on a per data source basis, allowing data from different data sources to be resampled based on differing ages. The data can be read from the HF database 406 by querying the HF database 406 based on one or more timestamps associated with the data that should be resampled.

At stage C, the resampler 404 resamples the data from the HF database 406. To resample the data, the resampler 404 analyzes the data as described above at stage E of FIG. 1, but using data that corresponds to a less frequent sampling interval. For example, consider a data source used to determine the number of read operations per second that was originally sampled every second. To originally determine the read operations per second at τₙ, the archiver 102 of FIG. 1 subtracted the count of read operations at τₙ from the count of read operations at τₙ₋₁. To resample the data at a fifteen second sampling interval, the resampler 404 subtracts the count of read operations at τₙ from the count of read operations at τₙ₋₁₅, dividing the difference by fifteen. The resulting value is the number of read operations per second for the time period between τₙ₋₁₅ and τₙ. The resampling of other types of statistics can vary accordingly.

At stage D, the resampler 404 stores the resampled data in the LT database 408. The resampler 404 can store the resampled data in the LT database using operations similar to those described above at stages F and G of FIG. 1. The resampler 404 stores the resampled data in the LT database 408, a database separate from the HF database 406, to reduce the load on the HF database 406. This prevents the writing of the resampled data from reducing the ability of the HF database 406 to handle the large amount of data being written to it.

At stage E, the resampler 404 removes the data read at stage B from the HF database 406. The resampler 404 removes the data by deleting the entries in the HF database 406 that were identified as corresponding to data that should be resampled. The resampler 404 can remove the data after storing the resampled data in the LT database 408 or can remove the data in conjunction with reading the data at stage B.

The process depicted at stages A-E of FIG. 4 can be repeated for varying levels of granularity. As described above, the data for a particular data source might be sampled at intervals of one second, which is stored for several hours. After the data ages, the data is resampled using a longer interval, such as fifteen seconds, which is stored for a day. Similarly, after the resampled data ages, it can be resampled again at an even longer interval, such as one minute, which might be stored for a month. In other words, as the granularity of the data decreases, the data is stored for a longer period of time.

FIG. 4 depicts the original data being stored in the HF database 406 and the resampled data being stored in the LT database 408. The particular database layouts can vary, however. For example, there may be a database for each sampling interval (one second, fifteen seconds, one minute, etc.), a single database with a table/data store for each sampling interval, or a combination thereof. The data for various sampling intervals might be stored in a single table/data store, with each entry indicating the associated sampling interval.

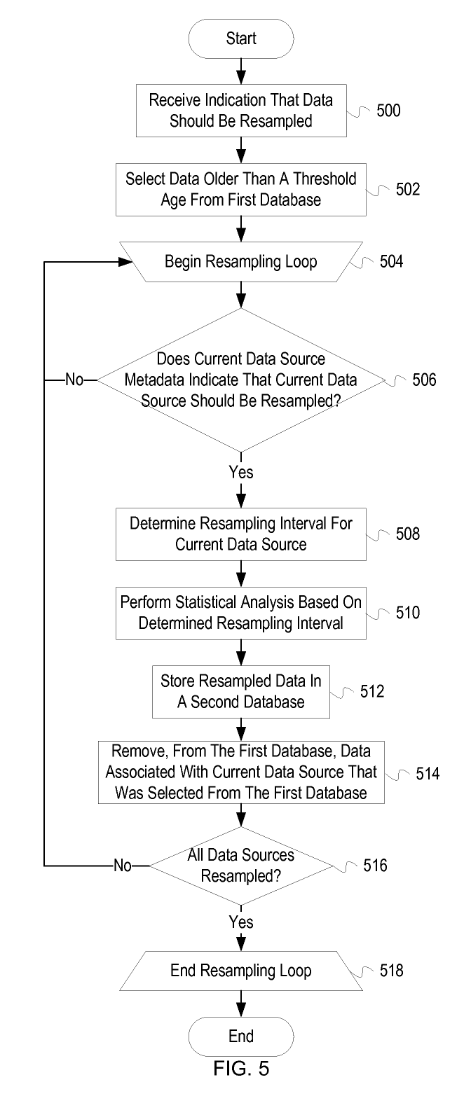

FIG. 5 depicts a flowchart of example operations for receiving and processing response to a request for a data source sample. The operations depicted in FIG. 5 can be performed by the resampler 404, depicted in FIG. 4, or another component configured to perform the operations.

At block 500, a resampler receives an indication that data should be resampled. The indication can be received as a function call, message, etc. For example, a timer may notify the resampler periodically that a certain amount of time has elapsed. The resampler might receive the indication as part of one or more other operations the resampler performs. For example, the resampler might periodically query a database to determine whether the database includes data older than a particular age threshold. Additionally, the resampler might allow for on-demand resampling. For example, a query from a client interface might request data based on a particular sampling interval. If the data is not available at the requested sampling interval, the archiver might request that the resampler resample the data according to the requested sampling interval. After the resampler receives the indication that data should be resampled, control then flows to block 502.

At block 502, the resampler selects data older than a threshold age from a first database. The specific threshold age used can be a static or configurable option. The threshold age can also be determined dynamically based on various factors, such as how quickly the size of the first database is increasing and/or how much storage space is available. The resampler can also utilize multiple threshold ages. For example, certain data sources might be subject to resampling at different threshold ages. Thus, the resampler might select data for individual data sources based on threshold ages associated with the respective data sources. After the resampler selects data older than the threshold age from the first database, control then flows to block 504.

At block 504, the resampler initializes or updates data associated with a resampling loop. During the first pass through block 504, the resampler initializes any data structures, variables, etc., used during the resampling loop. For example, the resampler might initialize variables to hold temporary values produced by statistical analysis operations. Additionally, the resampler initializes a current data source variable that indicates a data source that had data selected at block 502. During the subsequent passes through block 504, the resampler updates the data structures, variables, etc., as appropriate. For example, the resampler can update the current data source variable to indicate a different data source. After the resampler initializes or updates the data associated with the resampling loop, control then flows to block 506.

At block 506, the resampler determines whether metadata associated with the current data source indicates that the current data source should be resampled. As described above, when a data source is registered with an archiver, the registration can include metadata associated with the data source. The metadata can include one or more indications of resampling intervals and how long data sampled at a particular interval should be stored. Similarly, the metadata can indicate that the current data source is not to be resampled. If the resampler determines that the metadata associated with the current data source indicates that the current data source should be resampled, control then flows to block 508. If the resampler determines that the metadata associated with the current data source indicates that the current data source should not be resampled, control then flows back to block 504.

At block 508, the resampler determines a resampling interval for the current data source. The resampler can determine a resampling interval based on the sampling interval used for the data selected at block 502. For example, data that was sampled at one second might have a resampling interval of fifteen seconds; data that was sampled at fifteen seconds might have a resampling interval of one minute, etc. The resampling intervals can be global (i.e., apply to all data sources) or data source specific (i.e., be configured on a data source-by-data source basis). The resampler can determine the resampling interval by looking the resampling interval up in metadata based on the sampling interval used for the selected data. If the resampling interval is global, the resampler can look at global metadata. If the resampling interval is data source specific, the resampler can look at metadata associated with the current data source. After the resampler determines the resampling interval for the current data source, control then flows to block 510.

At block 510, the resampler performs a statistical analysis based on the resampling interval determined at block 508. The specific operations the resampler performs can be substantially similar to those described in relation to FIG. 3. When resampling, however, the resampler uses data from a subset of the samples used during previous statistical analyses. For example, if resampling data that was originally sampled at one second intervals, the resampler might use samples from fifteen second intervals, effectively ignoring the samples from within the fifteen second intervals. After the resampler performs the statistical analysis based on the determined resampling interval, control then flows to block 512.

At block 512, the resampler stores the resampled data in a second database. The operations performed by the resampler to store the resampled data in the second database can be substantially similar to those described at blocks 308, 310, and 312 of FIG. 3. The operations can vary, however. For example, resampled data might be written directly to the second database instead of being written to a cache first. After the resampler stores the resampled data in the second database, control then flows to block 514.

At block 514, the resampler removes the data associated with the current data source from the first database. To remove the source data from the first database, the resampler can delete each entry selected from the first database at block 502. After the resampler removes the source data from the first database, control then flows to block 516.

At block 516, the resampler determines whether all data sources in the data selected at block 502 have been resampled. In other words, the resampler determines whether all data sources from the selected data have been iterated over. If the resampler determines that all data sources in the selected data have been resampled, control then flows to block 518. If the resampler determines that all data sources in the selected data have not been resampled, control then flows back to block 504.

At block 518, the resampler ends the resampling loop, cleaning up and/or removing any data structures no longer in use. After the resampler ends the resampling loop, the process ends.

It should be noted that while the descriptions above refer to a data source being sampled according to a sampling interval, a sampling frequency or other technique for indicating when the data source should be sampled can be used. In particular, sampling interval and sampling frequency are interchangeable. Another technique for indicating when the data source should be sampled is specifying the specific times that the data source should be sampled. For example, it might be indicated that a particular data source is to be sampled at 1:00 A.M., 8:00 A.M., 1:00 P.M., and 11:00 P.M.

As example flowcharts, FIGS. 2, 3, and 5 present operations in an example order from which storage systems can deviate (e.g., operations can be performed in a different order than illustrated and/or in parallel; additional or fewer operations can be performed, etc.). For example, the sampling loop depicted in FIG. 2 might be initiated upon receiving an indication that the sample loop should begin. Thus, the archiver might perform additional operations for receiving the indication prior to block 204 of FIG. 2.

As will be appreciated by one skilled in the art, aspects of the disclosures herein may be embodied as a system, method or computer program product. Accordingly, aspects of the disclosures herein may take the form of hardware, software (including firmware, resident software, micro-code, etc.) or a combination of software and hardware aspects that may all generally be referred to herein as a “circuit,” “module” or “system.” Furthermore, aspects of the disclosures herein may take the form of a program product embodied in one or more machine readable medium(s) having machine readable program code embodied thereon.

Any combination of one or more machine readable medium(s) may be utilized. The machine readable medium may be a machine readable signal medium or a machine readable storage medium. A machine readable storage medium may be, for example, a system, apparatus, or device that uses electronic, magnetic, optical, electromagnetic, infrared, or semiconductor technology, or a combination thereof. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium does not include transitory, propagating signals.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Program code for carrying out operations for aspects of the disclosures herein may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine. Examples of a machine that would execute/interpret/translate program code include a computer, a tablet, a smartphone, a wearable computer, a robot, a biological computing device, etc.

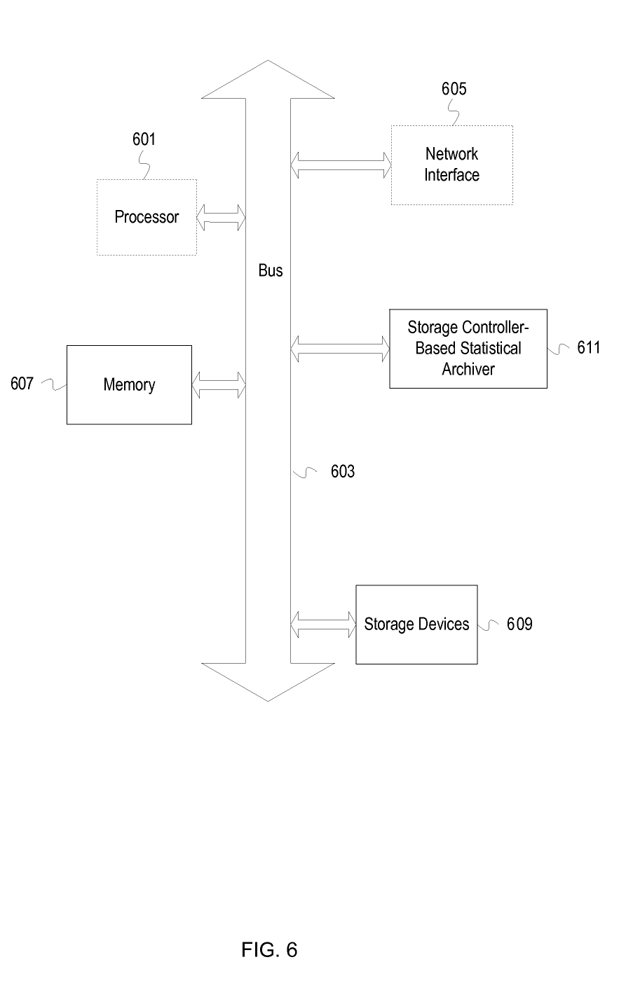

FIG. 6 depicts an example computer system including an archiver. The computer system includes a processor 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport®, InfiniBand®, NuBus, etc.), a network interface 605 (e.g., an ATM interface, an Ethernet interface, a Frame Relay interface, SONET interface, wireless interface, etc.), and a storage device(s) 609 (e.g., optical storage, magnetic storage, etc.). The computer system includes an archiver 611. The archiver 611 embodies functionality to implement features described above. The archiver 611 may perform operations including collecting and analyzing statistical data from various computer system components. The archiver 611 also may perform operations including storing the statistical data to a database and acting as an interface to the stored data. Any one of these functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601, the storage device(s) 609, and the network interface 605 are coupled to the bus 603. Although illustrated as being coupled to the bus 603, the memory 607 may be coupled to the processor 601.

While the examples are described with reference to various aspects and exploitations, it will be understood that these examples are illustrative and that the scope of the disclosures herein is not limited to them. In general, techniques for collecting, analyzing, and maintain storage system statistical data as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosures herein. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosures herein.

Use of the phrase “at least one of . . . or” should not be construed to be exclusive. For instance, the phrase “X comprises at least one of A, B, or C” does not mean that X comprises only one of {A, B, C}; it does not mean that X comprises only one instance of each of {A, B, C}, even if any one of {A, B, C} is a category or sub-category; and it does not mean that an additional element cannot be added to the non-exclusive set (i.e., X can comprise {A, B, Z}).

What is claimed is:

1. A method of storage performance data collection and analysis comprising:
requesting, by an operating system of a storage controller, a first sample of data from a first data source, wherein the first data source indicates data about a first performance characteristic of an active storage system associated with the storage controller;
receiving the first sample of data;
in response to receiving the first sample of data, determining a first statistic based, at least in part, on the first sample of data and a second sample of data, wherein the first sample of data and the second sample of data are associated with a first time interval;
storing the first statistic into a first data structure;
after determining the first statistic, determining a second statistic based, at least in part, on the first sample of data and a third sample of data, wherein the first sample of data and the third sample of data are associated with a second time interval of a different duration than the first time interval; and
storing the second statistic into a second data structure.

2. The method of claim 1 further comprising:
receiving a request to register the first data source, wherein the request to register the first data source comprises an indication of a length of the first time interval, wherein the length of the first time interval is a sampling interval for the first data source; and
receiving a request to register a second data source, wherein the request to register the second data source comprises an indication of a length of a third time interval, wherein the length of the third time interval is a sampling interval for the second data source, a duration of the third time interval being different than a duration of the first time interval.

3. The method of claim 2, wherein the request to register the first data source further comprises an indication of a fourth time interval that includes the first time interval and the second time interval.

4. The method of claim 1, wherein the first data structure is in a first database and the second data structure is in a second database.

5. The method of claim 1, wherein said storing the first statistic into the first data structure comprises writing an entry to a first row in the first data structure, wherein the entry comprises a timestamp associated with the first sample of data, the first sample of data, and a second sample of data, wherein the second sample of data comprises data from a second data source.

6. The method of claim 1, wherein the first data structure is stored in a cache, the method further comprising:
determining that data stored in the cache should be flushed to a storage device, wherein said determining that data stored in the cache should be flushed to a storage device comprises at least one of,
determining that the amount of data in the cache has reached a first threshold;
determining that a count of entries written to the cache since the data stored in the cache was last flushed to the storage device has reached a second threshold; and
determining that an amount of time has passed since the data stored in the cache was last flushed to the storage device; and
in response to determining that data stored in the cache should be flushed to a storage device, writing the first data structure to a storage device.

7. The method of claim 1 further comprising:
receiving a request for the first statistic and a third statistic;
determining that the first statistic is located in a cache;
determining that the second statistic is located on a storage device;
reading a first entry comprising the first statistic from the cache;
reading a second entry comprising the second statistic from the storage device; and
generating a response to the request for the first statistic and the third statistic, wherein the response comprises the first entry and the second entry.

8. The method of claim 1, wherein the first sample of data is requested by a first software module from a second software module, wherein the first software module is executing in the same process as the second software module.

9. A computer program product for analyzing storage system statistical data, the computer program product comprising:
a non-transitory machine readable medium having program code embodied therewith, the program code to:
receive a request to register a plurality of data sources from a component module, wherein the plurality of data sources are associated with at least one instance of the component module;
receive, from the component module, a first sample of data associated with the plurality of data sources, wherein the first sample of data is associated with a first time interval;
receive, from the component module, a second sample of data associated with the plurality of data sources, wherein the second sample of data is associated with a second time interval, the second time interval occurring after the first time interval;
receive, from the component module, a third sample of data associated with the plurality of data sources, wherein the third sample of data is associated with a third time interval, the third time interval occurring after the second time interval;
compute first statistics for the third time interval based, at least in part, on the second sample of data and the third sample of data; and
compute second statistics for a fourth time interval based, at least in part, on the first sample of data and the third sample of data, wherein the fourth time interval comprises the second time interval and the third time interval.

10. The computer program product of claim 9, wherein the request to register the plurality of data sources comprises, for each of the plurality of data sources,
a data source identifier;
a sampling interval;
one or more resampling intervals; and
one or more age thresholds associated with a respective resampling interval of the one or more resampling intervals.

11. The computer program product of claim 9, wherein the program code further comprises program code to:
write an entry to a cache, wherein the entry comprises a plurality of columns, wherein the plurality of columns include a timestamp associated with the second sample of data, an identifier of the instance of the component module, and a column for each of the plurality of data sources.

12. The computer program product of claim 9, wherein the program code further comprises program code to:
receive a request for the first statistics;
in response to reception of a request for the first statistics, read the first statistics from a first database;
determine that a gap exists in the first statistics, wherein a gap indicates that data was missing from at least one of the second sample of data or the third sample of data; and
indicate that the gap exists.

13. The computer program product of claim 9, wherein the program code further comprises program code to:
send a request for the first sample of data to the component module;
determine whether the first sample of data has been received; and
only in response to a determination that the first sample of data has been received, send a request for the second sample of data to the component module.

14. The computer program product of claim 9, wherein the program code further comprises program code to:
receive a request for third statistics for a fifth time interval;
in response to reception of a request for the third statistics for the fifth time interval, determine whether the third statistics have already been computed; and
in response to a determination that the third statistics have not already been computed, compute the third statistics for the fifth time interval.

15. An apparatus comprising:
a processor; and
a non-transitory machine readable medium having program code stored therein, the program code executable by the processor to cause the apparatus to,
repeatedly obtain first performance data from active data sources for components of a storage system into execution space of an operating system of the apparatus;
derive, within the operating system execution space, second performance data from the first performance data;
group the first performance data and the second performance data into a data unit that can be written to a data structure; and
write the data unit to the data structure.

16. The apparatus of claim 15, wherein the program code executable by the processor to cause the apparatus to repeatedly obtain the first performance data comprises program code executable by the processor to cause the apparatus to request the first performance data from the active data sources at defined intervals of time.

17. The apparatus of claim 15, wherein the program code further comprises program code executable by the processor to cause the apparatus to suspend obtaining performance data from the active data sources when storage input/output operations demand computing resources of the apparatus used for obtaining the performance data.

18. The apparatus of claim 15, wherein the program code executable by the processor to cause the apparatus to repeatedly obtain the first performance data comprises program code executable by the processor to cause the apparatus to request the first performance data from the active data sources at one second intervals of time.

19. The apparatus of claim 15, wherein the program code executable by the processor to cause the apparatus to write the data unit to the data structure comprises program code executable by the processor to cause the apparatus to write the data unit to a database with a single write operation.

20. The apparatus of claim 15, wherein the program code executable by the processor to cause the apparatus to group the first performance data and the second performance data into a data unit that can be written to a data structure comprises program code executable by the processor to cause the apparatus to group the first performance data and the second performance data by the components.
